(19) United States
(12) Patent Application Publication
(10) Pub. No.: US 2007/0056753 A1
(43) Pub. Date: Mar. 15, 2007

(54) System for the control and extinction of forest fires

(76) Inventor: Jose Antonio Serrano Molina, Montcada I Reixac (ES)

Correspondence Address: WOLF BLOCK SCHORR AND SOLIS-COHEN LLP, 250 PARK AVENUE, NEW YORK, NY, 10177, US

(21) Appl. No.: 10/557,661

(22) PCT Filed: May 19, 2004
(86) PCT No.: PCT/IB04/01621

§ 371 Date: Nov. 21, 2005

(30) Foreign Application Priority Data
May 23, 2003 (ES) P-200301204

(51) Int. Cl. A62C 37/10

(52) U.S. Cl. 169/60; 239/70

(57) ABSTRACT

System for the control and extinction of forest fires, which includes means for detecting (3) the fire, water-supply means (1) and water-distribution means (2), characterized in that said water-distribution means (2) include a fixed installation in the terrain and in that the system includes real-time control means (5) that pick up the signal from the detecting means (3) and act on the water-supply means (1) to the installation. Thanks to these characteristics the response time to the fire is immediate and deforestation is not necessary for installing the system.

This invention relates to a system which has an immediate response time for the control and extinction of forest fires.

### BACKGROUND OF THE INVENTION

Known in the art are systems for the control of forest fires that comprise firebreak systems. Firebreak systems are cleared areas of land used to hold up the propagation of a fire. Such systems have the disadvantage that in order to implement them strips of land of some 30-40 metres in width have to be deforested, which involves a significant environmental impact and is therefore difficult to apply in natural parks and protected areas.

Another disadvantage of firebreak systems is the high cost of maintenance of the deforested zones and the difficulty of implementing the system in forest zones with difficult access.

Also known are systems for the control and extinction of forest fires which include fire-detection means, water-supply means and water-distribution means. The water-supply means comprise tanks and pumping facilities associated with those tanks, swimming pools near the zone of the fire, tankers, etc. The water-distribution means include human teams mainly made up of firefighter brigades close to the place of the fire, which teams basically act on the fire by applying water with hoses, hydroplanes, etc.

Such systems have the disadvantages set out below.
Heavy investment in firefighter brigades close to the scene of the fire in order to ensure a minimum response time.
Need to build roads and trails to provide speedy access for firefighter teams.
Deforestation of strips of forested land in order to build roads and trails for the access of firefighter brigades to the firebreak zone.
High maintenance cost of deforested zones.
High job risk for the firefighters during the work of fire extinction and control.

### DESCRIPTION OF THE INVENTION

The objective of this invention is to resolve the disadvantages mentioned, by developing a system for the control and extinction of fires with an immediate response time.

In accordance with this objective, the system of this invention is characterized in that said water-distribution means include a fixed installation on the ground and in that the system includes real-time control means that pick up the signal from the detecting means and act upon the water-supply means to the installation.

Preferably, said real-time control means include programmable logic controls (PLCs), programmable robots and communications programmers through the general packet radio system (GPRS).

Thanks to these characteristics, the system of this invention has advantages over the systems known in the state of the art, in that the response-time to the fire is immediate, without needing to have firefighter brigades close to the place in order to ensure a minimum response time. Nor is it necessary to deforest parts of the woods in order to install it, or to build access roads and trails, which means that it can be used without problems in natural parks and protected areas. Furthermore, it is a safe system for the firefighter brigades.

Another advantage of the system of this invention is that it makes automatic activation of emergency and action plans possible.

Preferably, said fire detecting means are infrared cameras which make it possible to detect and locate the fire. Moreover, as the heat emitted by the fire is detected, the system is activated in the initial phase of the fire.

Preferably, the system includes means for detecting pressure losses in the fixed installation in the terrain. Potential leaks can be detected thanks to these means.

Preferably, the system includes means for detecting wind speed and direction. Such means allow decisions to be taken to increase water pressure in order to overcome the force of the wind.

Preferably, the water-distribution installation includes at least one water pipe provided with a plurality of sprinklers, and that at least one water pipe provided with a plurality of sprinklers is mounted vertically and parallel to a tree or shrub.

Thanks to these characteristics of the installation, the water distribution is carried out over uniform strips of land, so that the watered zones constitute natural firebreaks.

Preferably, said at least one pipe provided with a plurality of sprinklers includes at least one sprinkler situated at the height of the upper part of the tree's or shrub's crown, in such a way that it can cover a very wide strip of terrain.

Advantageously, the system includes a photovoltaic reflector situated at the upper part of said tree's or shrub's crown in order to signal the presence of the pipe provided with a plurality of sprinklers. Thanks to this reflector, falling of the tree or shrub can be detected and therefore also falling of the vertical pipe provided with a plurality of sprinklers which was secured to said tree or shrub.

Advantageously, the system includes photovoltaic panels for its electricity supply.

### BRIEF DESCRIPTION OF THE DRAWINGS

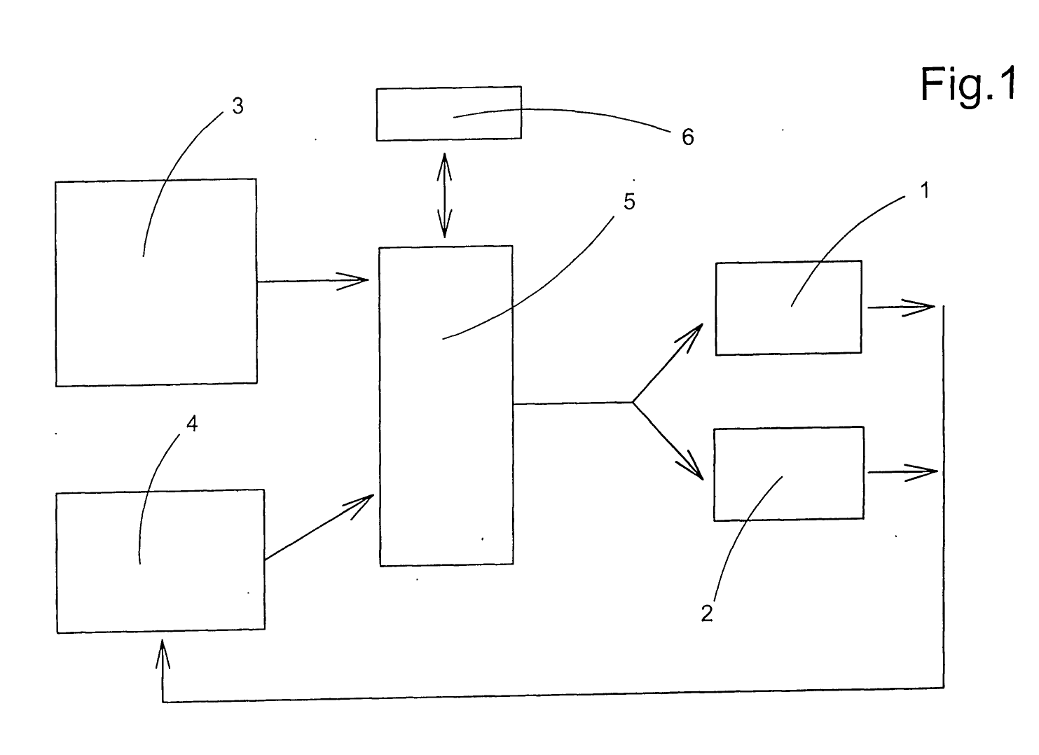

For a better understanding of all that has been set out, FIG. 1 consists in a block diagram of the operation of the system for the control and extinction of forest fires.

### DESCRIPTION OF A PREFERRED EMBODIMENT

According to a preferred embodiment of this invention and as shown in FIG. 1, the system for the control and extinction of forest fires includes means 1 for supplying water-distribution means 2 that include a water installation fixed in the terrain. The supplying means 1 consist in the installation of a water tank and pumping equipment in the zone of forest terrain to be protected. This tank will have a white, extendible, elastic dome to prevent evaporation of the water and the entry of foreign bodies such as leaves, branches, etc. The dome will be driven by an electric motor. The water installation will include main piping from which there emerge by way of secondary branch-lines pipes arranged in zigzag fashion along the slope of the mountain or forest terrain to be protected. These secondary pipes will in turn have tertiary branch-lines or piping with sprinklers, mounted vertically and fixed to a guide, which will in turn be attached to the closest tree or shrub. Each one of these pipes will have three sprinklers, one of them located at the height of the tree's crown, another halfway up the trunk and another near the ground. The strip of terrain to be moistened, covered by each of the secondary pipes laid out in zigzag pattern along the slope of the mountain or forest terrain, will have a width of some 35-40 metres. This width is equivalent to that of the firebreaks of the state of the art.

The pipes used for the water-distribution installation will be made of fire-resistant material, will have high moisture resistance and will have organic inhibitors for protection from fauna.

Up at the top of each tree on which a guide is fixed with piping fitted with sprinklers will be mounted a photovoltaic reflector. These reflectors will serve to show from a distance the routes followed by the secondary branch-lines, as well as the trees or shrubs to which the tertiary branch-lines bearing the sprinklers are attached.

According to the preferred embodiment of this invention, the system includes fire detecting means 3 based on infrared cameras mounted on control towers. From these towers, the cameras detect the heat or infrared radiation emitted by any fire in the protection zone in which the system is installed.

The system may have other sensors or wind speed and direction detecting means 4, means for detecting possible system faults or irregularities such as pressure losses in the installation piping, means for detecting the water tank levels, fuel tank levels, battery levels, etc.

The signals of the detecting means 3,4 will be picked up by the real-time control means 5, which are programmable logic controls, also known as PLCs, which through programmable robots and communications programmers using the general packet radio system (GPRS) will carry out various actions such as starting up the water installation pumps, calling the firefighter brigades, calling maintenance personnel, altering the water output pressure, opening the extendible dome of the water tank, starting the motor for recharging the battery from the alternator, etc.

The system, which as can be appreciated has an immediate response time to the fire, will always act under the supervision of a user 6 who will check and/or order the actions to be carried out, through the GPRS system.

There follows a description of a practical example of the way the system operates.

The infrared camera detects fire and transmits a signal to the PLC, which identifies the position or the sector in which the fire is located. Then, through a communications programmer using the GPRS system, the PLC places a call to the user. If the user does not answer, it proceeds with a different number from the list. If there is still no answer by the time all numbers on the list have been rung, the PLC waits for a minute and then makes the calls over again.

Users answering the call from the PLC must identify themselves by means of a code number, which is then checked by the PLC. If the code number is not correct, users may try a further three numbers. If the number is still not correct, the PLC makes another call to another number.

If the code number is correct, the PLC transmits the information about the sector in which the fire has been detected and requests action to be taken. Users reply in the affirmative, proposing start-up of the water-distribution installation pumps. The PLC must check the action.

If the action is not correct, users can have up to a total of four attempts. If the action remains incorrect, the PLC proceeds to call another number.

If the action is correct, users must identify themselves again with the code number. If the user code is correct the PLC gives a signal to the programmable robot to act on the installation pumps motor.

Once the action has been implemented, the PLC notifies the correct action and asks for further actions. If the user replies in the affirmative the PLC checks the new action, such as calling the firefighter brigades, and then continues as before. If the user replies in the negative, the PLC terminates the operation.

The system described does not require deforestation of the protection zones, and is therefore very suitable for protected areas, natural parks and for protecting forest zones close to residential estates and meteorological stations.

1. System for the control and extinction of forest fires comprising fire detecting means, water-supply means, real-time control means that pick up the signal from the detecting means and act upon the water-supply means to the installation, and water-distribution means, said water-distribution means including a fixed installation on the ground which includes at least one water pipe provided with a plurality of sprinklers, wherein said at least one water pipe is mounted vertically and parallel to a tree or shrub and includes a photovoltaic reflector situated at the upper part of said tree's or shrub's crown in order to signal the presence of the pipe provided with a plurality of sprinklers.

2. The system according to claim 1, wherein said real-time control means comprise programmable logic controls (PLC), programmable robots and communications programmers through the general packet radio system (GPRS).

3. The system according to claim 1, wherein said fire detecting means are infrared cameras.

4. The system according to claim 1, further comprising means for detecting pressure losses in the fixed installation in the terrain.

5. The system according to claim 1, further comprising means for detecting wind speed and direction.

6. The system according to claim 1, wherein said at least one pipe provided with a plurality of sprinklers includes at least one sprinkler situated at the height of the upper part of the tree's or shrub's crown.

7. The system according to claim 1, further comprising photovoltaic panels for its electricity supply.
